(19) United States
(12) Patent Application Publication
(10) Pub. No.: US 2005/0047967 A1
(43) Pub. Date: Mar. 3, 2005

(54) Microfluidic component providing multi-directional fluid movement

(75) Inventors: Sway Chuang, Ping Don (TW); Chen-Kuei Chung, Tainan (TW); Chung-Chu Chen, Taizhang (TW)

Correspondence Address: TUNG & ASSOCIATES, Suite 120, 838 W. Long Lake Road, Bloomfield Hills, MI, 48302, US

(73) Assignee: Industrial Technology Research Institute

(21) Appl. No.: 10/654,314

(22) Filed: Sep. 3, 2003

(51) Int. Cl. B01L 3/00

(52) U.S. Cl. 422/100; 436/180

(57) ABSTRACT

A microfluidic component, a method for fabrication thereof and a method for operation thereof provide a laminated assembly of a substrate and a top plate. The substrate and the top plate have defined therebetween a minimum of one collection chamber and a minimum of two connection channels connected to the minimum of one collection chamber. The minimum of two collection channels provides the microfluidic component with enhanced functionality.

### BACKGROUND OF THE INVENTION

1. Field of the Invention

The invention relates generally to microfluidic systems. More particularly, the invention relates to microfluidic systems with enhanced functionality.

2. Description of the Related Art

Microfluidic systems are microelectromechanical systems (MEMS) that comprise micropumps, microvalves, microchannels, microchambers and micromixers fabricated within a laminated assembly. The systems are often used in chemical analysis and screening applications where small volumes of chemical or pharmaceutical materials may be employed to provide large numbers of analyses and assays. The systems may also be employed in micrometered drug delivery applications. The systems are particularly desirable since they are generally cost and space efficient.

While microfluidic systems are quite useful within several applications, they are nonetheless not entirely without problems. In particular, microfluidic systems often do not possess adequate functionality to accommodate more complex multi-reagent chemical analyses.

The invention is thus directed towards providing microfluidic systems with enhanced functionality.

Various microfluidic systems and microfluidic components having desirable properties have been disclosed in the microfluidic art.

Included but not limiting are systems and components disclosed within: (1) Bernard et al., “Thin-Film Shape-Memory Alloy Actuated Micropumps,” J. Microelectromechanical Systems, Vol. 7(2), June 1998, pp. 245-51; (2) Yang et al., “Design, Fabrication and Testing of Micromachined Silicone Rubber Membrane Valves,” J. Microelectromechanical Systems, Vol. 8(4), December 1999, pp. 393-402; (3) Gong et al, “Design, Optimization and Simulation on Microelectromagnetic Pump,” Sensors and Actuators, 83(2000), pp. 200-07; and (4) Jeong et al., “Fabrication and Test of a Thermopneumatic Micropump With a Corrugated p+ Diaphragm,” Sensors and Actuators 83(2000), pp. 240-55.

Additional microfluidic systems within enhanced functionality are desirable. The invention is directed towards that object.

### SUMMARY OF THE INVENTION

A first object of the invention is to provide a microfluidic system.

A second object of the invention is to provide a microfluidic system with enhanced functionality.

In accord with the objects of the invention, the invention provides: (1) a microfludic component with enhanced functionality; (2) a method for fabricating the microfluidic component; and (3) a method for operating the microfluidic component.

The microfluidic component comprises a laminated assembly comprising a substrate and a top plate. The substrate and the top plate define therebetween a minimum of one collection chamber and a minimum of two connection channels connected to the minimum of one collection chamber.

The microfluidic component in accord with the invention contemplates a method for fabricating the microfluidic component and a method for operating the microfluidic component.

The invention provides a microfluidic system with enhanced functionality.

The invention realizes the foregoing object by providing a microfluidic component comprising a laminated assembly comprising a substrate and a top plate. The substrate and the top plate define therebetween a minimum of one collection chamber and a minimum of two connection channels connected to the minimum of one collection chamber. By providing the minimum of two connection channels, directional options of fluid flow within the microfluidic component are increased and a microfluidic system incorporating the microfluidic component may be fabricated with enhanced functionality.

### BRIEF DESCRIPTION OF THE DRAWINGS

The objects, features and advantages of the invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic plan-view diagram of a microfluidic component in accord with the invention.

FIG. 2, FIG. 3 and FIG. 4 shows a series of schematic cross-sectional diagrams illustrating the results of progressive stages in fabricating the microfluidic component in accord with the invention.

FIG. 5 and FIG. 6 show a pair of schematic cross-sectional diagrams illustrating exemplary modes of operation of the microfluidic component in accord with the invention.

### DESCRIPTION OF THE PREFERRED EMBODIMENT

The invention provides a microfluidic system with enhanced functionality.

The invention realizes the foregoing object by providing a microfluidic component comprising a laminated assembly comprising a substrate and a top plate. The substrate and the top plate define therebetween a minimum of one collection chamber and a minimum of two connection channels connected to the minimum of one collection chamber. By providing the minimum of two connection channels, directional options of fluid flow within the microfluidic component are increased and a microfluidic system incorporating the microfluidic component may be fabricated with enhanced functionality.

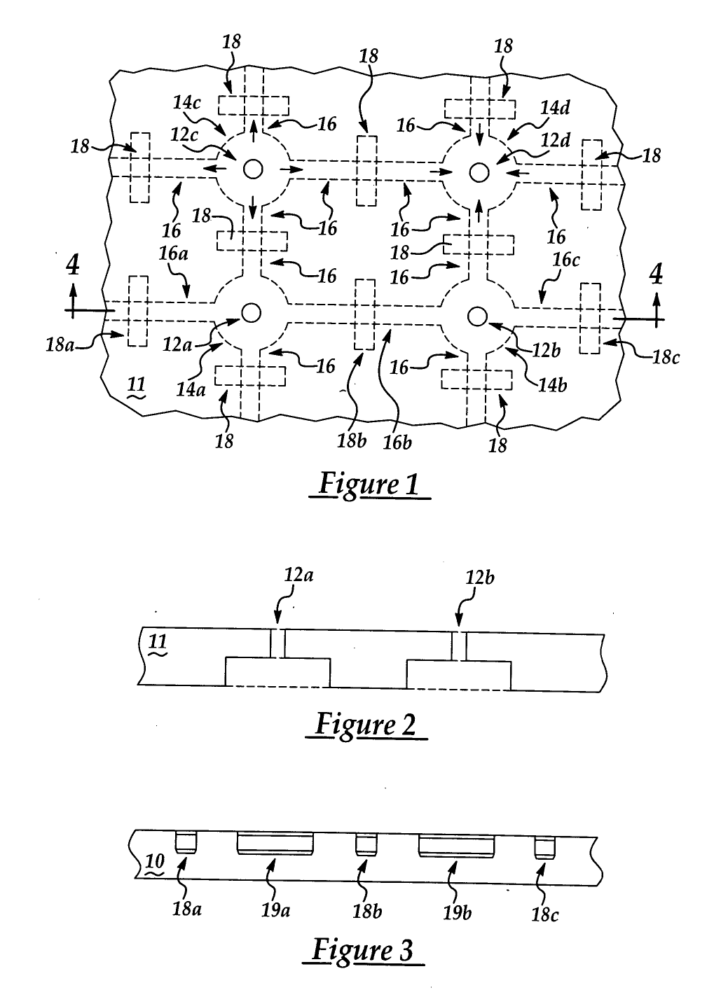

FIG. 1 shows a schematic plan-view diagram of a microfluidic component in accord with a preferred embodiment of the invention.

The microfluidic component comprises a substrate that will be more specifically illustrated in the cross-sectional diagrams that follow. A cover plate 11 is assembled to the substrate. A series of inlet/outlet ports 12a, 12b, 12c and 12d is formed within the cover plate 11 and a series of collection chambers 14a, 14b, 14c and 14d is defined interposed between the substrate and the cover plate 11. A series of connection channels 16 (with specific connection channels designated as 16a, 16b and 16c for future reference) connects the series of collection chambers 14a, 14b, 14c and 14d in a nominally rectangular array. Finally, a series of valves 18 (with specific valves designated as 18a, 18b and 18c for future reference) is interposed between the series of collection chambers 14a, 14b, 14c and 14d in a fashion intended to valve flow of a fluid within the series of connection channels 16.

The preferred embodiment in accord with FIG. 1 illustrates the invention within the context of four connection channels 16 connected to each collection chamber 14a, 14b, 14c or 14d. FIG. 1 is also intended to extend in all four directions such that the four connection channels 16 connected to each collection chamber 14a, 14b, 14c or 14d are also connected at their distal ends to a series of four additional separated collection chambers. However, the invention is not intended to be limited to the geometric configuration of FIG. 1. Rather, the invention contemplates at least two connection channels 16 connected to each collection chamber 14a, 14b, 14c or 14d, more preferably three, yet more preferably four (arranged in a rectangular array) and still preferably at least four. A number of connection channels 16 that may be connected to a collection chamber 14a, 14b, 14c or 14d may in part be limited by a fabrication method for defining a connection channel 16 and a collection chamber 14a, 14b, 14c or 14d interposed between a substrate and a top plate. Alternatively, the number of connection channels 16 that may be connected to a collection chamber 14a, 14b, 14c or 14d may derive from fluid flow limitations within the microfluidic component of FIG. 1.

Significant to the invention is the connection of at least two connection channels 16 (and preferably more) to a single collection chamber 14a, 14b, 14c or 14d. The two connection channels 16 connect the collection chamber 14a, 14b, 14c or 14d to at least two additional separated collection chambers 14a, 14b, 14c or 14d. Given this feature, and as illustrated in FIG. 1, a fluid when introduced into collection chamber 14c may upon appropriate valving of a series of valves 18 flow into more than one (i.e., up to four) additional collection chambers. In addition, and as also illustrated in FIG. 1, a plurality of fluids (i.e., up to four) may be introduced into collection chamber 14d. This feature provides the microfluidic component of FIG. 1 with enhanced functionality.

FIG. 2 to FIG. 4 show a series of schematic cross-sectional diagrams illustrating the results of progressive stages in fabricating the microfluidic component of FIG. 1.

FIG. 2 illustrates the cover plate 11. The cover plate 11 has the pair of inlet/outlet ports 12a and 12b formed therethrough. The cover plate 11 also has an irregular bottom surface that assists in part in forming the pair of collection chambers 14a and 14b as illustrated in FIG. 1.

The cover plate 11 may be formed of any of several material as are conventional in the art, including but not limited to glass, ceramic and semiconductor substrate materials. Typically, the cover plate 11 is formed to a thickness of from about 0.05 to about 0.5 millimeters.

FIG. 2 shows a substrate 10. The series of valves 18a, 18b and 18c (illustrated in an open position), as well as a pair of pumps 19a and 19b (illustrated in an non-operative position), are formed within the substrate 10.

The substrate 10 may also be formed from any of several materials as are conventional in the art. Such materials will also typically include glass materials, ceramic materials and semiconductor substrate materials. Typically, the substrate 10 comprises at least in part a semiconductor substrate material with sufficient circuitry to independently actuate the series of valves 18a, 18b and 18c and the pair of pumps 19a and 19b.

Each of the series of valves 18a, 18b and 18c and the pair of pumps 19a and 19b may be actuated employing methods as are conventional. Such methods may include, but are not limited to electrostatic, piezoelectric, electromagnetic, thermal and thermo-pneumatic methods. A thermo-pneumatic method is particularly desirable. Thus, each of the series of valves 18a, 18b and 18c and the pair of pumps 19a and 19b preferably comprises: (1) a thermal element at a base of an aperture within the substrate 10; (2) an expandable gas as a working fluid filling the aperture; and (3) a membrane enclosing the aperture including the expandable gas. Any conventional expandable gas may be employed. Silicon membranes are common in the art. Aperture dimensions may also be conventional.

FIG. 4 illustrates the results of laminating and mating the cover plate 11 as illustrated in FIG. 2 with the substrate 10 as illustrated in FIG. 3. Together, the laminated assembly of the substrate 10 and the cover plate 11 defines the pair of collection chambers 14a and 14b as well as the series of connection channels 16a, 16b and 16c. The pair of connection channels 16a and 16b is connected to the collection chamber 14a. The pair of connection channels 16b and 16c is connected to the collection chamber 14b.

While FIG. 4 illustrates the pair of collection chambers 14a and 14b as defined largely within the cover plate 11, such is not required within the invention. The pair of collection chambers 14a and 14b may be defined largely by the cover plate 11, the substrate 10 or equally by the cover plate 11 and the substrate 10.

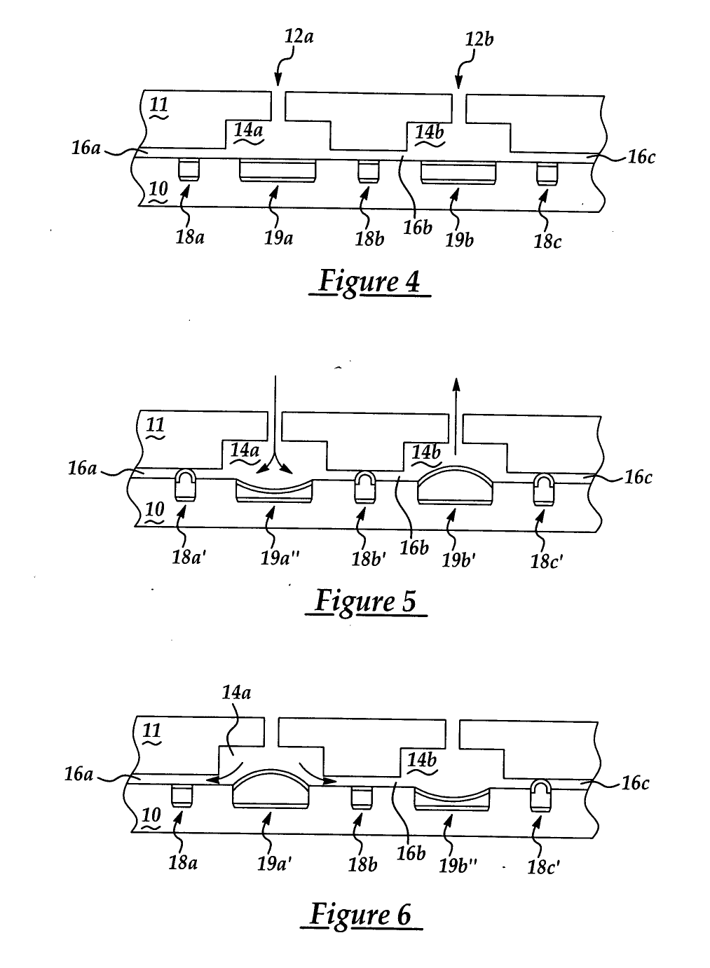

FIG. 5 and FIG. 6 illustrate a pair of modes of operation of the microfluidic component of FIG. 4.

FIG. 5 illustrates a series of closed valves 18a′, 18b′ and 18c′ formed incident to thermo-pneumatic actuation of the valves 18a, 18b and 18c as illustrated in FIG. 4. The series of closed valves 18a′, 18b′ and 18c′ closes the series of connection channels 16a, 16b and 16c connected to the pair of collection chambers 14a and 14b.

FIG. 5 also illustrates negative actuation of the pump 19a to form a suction pump 19a″ and positive actuation of the pump 19b to form a expulsion pump 19b′. Under such circumstances, a fluid may be drawn into the collection chamber 14a and expelled from the collection chamber 14b.

FIG. 6 illustrates an additional mode of operation of the microfluidic component of FIG. 4.

FIG. 6 illustrates a pair of open valves 18a and 18b and a closed valve 18c′. In addition, FIG. 6 illustrates an expulsion pump 19a′ and a suction pump 19b″. Under such circumstances, and given an additional check valving with respect to the inlet/outlet port 12a (i.e., a check valve may be installed within the collection chamber 14a and covering the inlet/outlet port 12a that accesses the collection chamber 14a), a fluid my be propelled into the connection channels 16a and 16b, and in particular drawn into the collection chamber 14b.

The preferred embodiment illustrates a microfluidic component, its method of fabrication and its method of operation. The microfluidic component may be employed within a microfluidic system to provide the microfluidic system with enhanced functionality. The microfluidic component realizes the foregoing object by employing a minimum of two connection channels connected to a collection chamber within the microfluidic component.

The preferred embodiment of the invention is illustrative of the invention rather than limiting of the invention. Revisions and modifications may be made to methods, materials, structures and dimensions of a microfluidic component in accord with the preferred embodiment while still providing a microfluidic component in accord with the invention, further in accord with the accompanying claims.

1. A microfluidic component comprising a laminated assembly comprising a substrate and a top plate, where the substrate and the top plate define therebetween a minimum of one collection chamber and a minimum of two connection channels connected to the minimum of one collection chamber.

2. The microfluidic component of claim 1 further comprising a minimum of two valves, one each constructed within the minimum of two connection channels.

3. The microfluidic component of claim 1 further comprising a minimum of two additional separated collection chambers defined between the substrate and the top plate one each connected to an end of each of the minimum of two connection channels opposite the minimum of one collection chamber.

4. The microfluidic component of claim 1 wherein the minimum of two connection channels is four connection channels.

5. The microfluidic component of claim 4 wherein the four connection channels are connected to four additional separated collection chambers defined between the substrate and the top plate.

6. The microfluidic component of claim 1 wherein the minimum of two connection channels is at least four connection channels.

7. The microfluidic component of claim 1 further comprising a pump within the collection chamber.

8. A method for fabricating a microfluidic component comprising:
providing a substrate and a top plate; and
assembling the substrate to the top plate such as to provide a laminated assembly defining between the substrate and the top plate a minimum of one collection chamber and a minimum of two connection channels connected to the minimum of one collection chamber.

9. The method of claim 8 further comprising constructing a minimum of two valves within the microfluidic component, one each constructed within the minimum of two connection channels.

10. The method of claim 8 further comprising defining a minimum of two additional separated collection chambers between the substrate and the top plate one each connected to an end of each of the minimum of two connection channels opposite the minimum of one collection chamber.

11. The method of claim 8 wherein the minimum of two connection channels is four connection channels.

12. The method of claim 11 wherein the four connection channels are connected to four additional separated collection chambers defined interposed between the substrate and the top plate.

13. The method of claim 8 wherein the minimum of two connection channels is at least four connection channels.

14. The method of claim 8 further comprising constructing a pump within the collection chamber.

15. A method for operating a microfluidic component comprising:
providing a microfluidic component comprising a laminated assembly comprising a substrate and a top plate, where the substrate and the top plate define therebetween a minimum of one collection chamber and a minimum of two connection channels connected to the minimum of one collection chamber;
introducing a fluid into the minimum of one collection chamber; and
pumping the fluid from the minimum of one collection chamber into the minimum of two connection channels.

16. The method of claim 15 wherein the microfluidic component further comprises a minimum of two valves, one each constructed within the minimum of two connection channels.

17. The method of claim 15 wherein the microfluidic component further comprises a minimum of two additional separated collection chambers defined between the substrate and the top plate one each connected to an end of each of the minimum of two connection channels opposite the minimum of one collection chamber.

18. The method of claim 15 wherein the minimum of two connection channels is four connection channels.

19. The method of claim 18 wherein the four connection channels are connected to four additional separated collection chambers defined between the substrate and the top plate.

20. The method of claim 15 wherein the minimum of two connection channels is at least four connection channels.
